(19) United States
(12) Patent Application Publication
(10) Pub. No.: US 2026/0077762 A1
(43) Pub. Date: Mar. 19, 2026

(54) VEHICLE STEERING AUTOMATIC COLLISION AVOIDANCE SYSTEM AND METHOD

(71) Applicant: CHUNG-PING HSU, Taipei City (TW)

(72) Inventor: CHUNG-PING HSU, Taipei City (TW)

(21) Appl. No.: 19/319,713

(22) Filed: Sep. 4, 2025

(30) Foreign Application Priority Data
Sep. 13, 2024 (TW) 113134745

(51) Int. Cl. B60W 30/09; B60W 10/18; B60W 10/20; B60W 30/095

(52) U.S. Cl. CPC B60W 30/09; B60W 10/18; B60W 10/20; B60W 30/0953; B60W 2420/403; B60W 2552/05

(57) ABSTRACT

A vehicle steering automatic collision avoidance system includes a driving control computer connected to an autonomous emergency braking assistance system and an automobile steering automatic collision avoidance system. The autonomous emergency braking assistance system is configured to provide autonomous emergency braking assistance information. The vehicle steering automatic collision avoidance system is configured to provide steering collision-avoidance decision information, when activated. The driving control computer is capable of integrating the autonomous emergency braking assistance information and the steering collision-avoidance decision information.

### CROSS REFERENCE TO RELATED APPLICATIONS

The present invention claims benefit of Taiwan Application No. 113134745, filed in Taiwan Intellectual Property Office on Sep. 13, 2024, the same disclosure of which is also filed in Chinese Notional Intellectual Property Administration on Sep. 13, 2024 as Chinese Application No. 202411283189.X, the disclosure of which is incorporated by reference herein.

### BACKGROUND OF THE INVENTION

### Field of the Invention

The present disclosure relates to a vehicle automatic emergency braking assistance system, particularly relates to a vehicle automatic emergency braking assistance system including an automobile steering automatic collision avoidance system.

### Description of Related Art

With the advancement in technology, most vehicles on the market today are equipped with Autonomous Emergency Braking (AEB) systems to help prevent collisions while driving. However, the AEB systems currently on the market are designed to prevent rear-end collisions with vehicles in front at different speeds. These AEB systems mainly use radar sensors installed at the front of the vehicle to emit radar waves that detect the distance between the host vehicle and the vehicle (or obstacle) ahead. If the detected distance falls below a preset threshold, the system activates the vehicle's braking mechanism to perform emergency braking and issues a warning to prevent collisions or rear-end accidents.

However, many traffic accidents during driving are caused by visual blind spots resulting from the vehicle's structure. For example, while turning, the vehicle's A-pillar can easily block the driver's view of pedestrians, vehicles, or traffic signals, leading to traffic accidents. However, currently available AEB systems on the market are unable to detect the relative position and angular relationship of moving objects located in the blind spot created by the A-pillar. Therefore, during a turn, since the A-pillar blind spot is outside the detection and braking activation range of existing AEB systems, and thus traffic accidents while turning still occur frequently.

In order to reduce the frequent occurrence of such accidents, it is necessary to provide an AEB system with a wider field of view during vehicle steering, such that the AEB system can also detect driving obstacles located within the A-pillar blind spot and activating braking warnings accordingly. This would help prevent collisions and reduce traffic accidents, which is the problem the present disclosure aims to solve.

### BRIEF SUMMARY OF THE INVENTION

The present disclosure provides a system and method of vehicle steering automatic collision avoidance to resolve the above-mentioned problems existing in the prior art.

A vehicle steering automatic collision avoidance system in accordance with the present disclosure is provided. The vehicle steering automatic collision avoidance system includes a driving control computer connected to an autonomous emergency braking (AEB) assistance system and an automobile automatic collision avoidance system. The autonomous emergency braking assistance system is configured to provide autonomous emergency braking assistance information. The vehicle steering automatic collision avoidance system, when activated, is configured to provide steering collision-avoidance decision information. The driving control computer is capable of integrating the autonomous emergency braking assistance information and the steering collision-avoidance decision information.

Furthermore, the vehicle steering automatic collision avoidance system includes an urban or highway determination and intervention module providing urban or highway road information. The driving control computer may activate the vehicle steering automatic collision avoidance system based on the urban or highway road information.

Furthermore, the vehicle steering automatic collision avoidance system includes a driving speed and extended turning area determination module. The driving speed and extended turning area determination module is configured to provide an extended turning area determination information.

Furthermore, the vehicle steering automatic collision avoidance system includes a steering system threshold variation and tire trajectory prediction module. The steering system threshold variation and tire trajectory prediction module is configured to provide steering system threshold variation information and vehicle future movement trajectory prediction information.

Furthermore, the automobile steering automatic collision avoidance system includes a wide-angle camera activation module. The wide-angle camera activation module is configured to provide a wide-angle activation signal to a wide-angle camera based on the extended turning area determination information and the vehicle future movement trajectory prediction information.

Furthermore, the wide-angle camera is configured to provide wide-angle camera information.

Furthermore, the automobile steering automatic collision avoidance system includes a turning-offset red-frame obstacle determination module. The turning-offset red-frame obstacle determination module is configured to provide the steering collision avoidance decision information to the driving control computer based on the wide-angle camera information and the vehicle future movement trajectory prediction information.

Furthermore, the urban or highway determination and intervention module is a traffic sign recognition system.

Furthermore, the extended turning area determination information includes a turning determination distance.

Furthermore, the steering system threshold variation information includes a tire rotation direction extension line, a left-side threshold, and a right-side threshold.

Furthermore, the vehicle future movement trajectory prediction information includes a future movement trajectory extension line, a warning window, and a warning area.

A vehicle steering automatic collision avoidance method in accordance with the present disclosure is provided. The vehicle steering automatic collision avoidance method includes following steps: Step S1: determining whether to activate a vehicle steering automatic collision avoidance system by a driving control computer based on urban or highway information; Step S2: providing extended turning area determination information by a driving speed and extended turning area determination module; Step S3: providing steering system threshold variation information and the vehicle future movement trajectory prediction information by a steering system threshold variation and tire trajectory prediction module; Step S4: providing a wide-angle activation signal to a wide-angle camera based on the determination results of Steps S2 and S3 by a wide-angle camera activation module; Step S5: providing wide-angle camera information by the wide-angle camera; Step S6: providing steering collision avoidance decision information to the driving control computer by a turning deviation red-box obstacle determination module based on the wide-angle camera information and the vehicle future movement trajectory prediction information; Step S7: integrating the steering collision avoidance decision information with automatic emergency braking assistance information provided by an automatic emergency braking assistance system, using the driving control computer.

Furthermore, the extended turning area determination information includes a turning determination distance, and the turning determination distance varies according to the forward speed of the vehicle.

Furthermore, the steering system threshold variation information includes a tire rotation direction extension line, a left-side threshold, and a right-side threshold. The tire rotation direction extension line and the left-side threshold or the right-side threshold form an intersection point, and a turning operation of the vehicle is determined based on a relative position between the intersection point and the turning determination distance.

Furthermore, the vehicle future movement trajectory prediction information includes a future movement trajectory extension line, a warning window, and a warning area.

### BRIEF DESCRIPTION OF THE DRAWINGS

FIG. 1 is a block diagram illustrating a vehicle steering automatic collision avoidance system according to an exemplary embodiment of the disclosure.

FIG. 2 is a block diagram illustrating a vehicle steering automatic collision avoidance system including an automobile steering automatic collision avoidance system and an urban or highway determination and intervention module according to an exemplary embodiment of the disclosure.

FIG. 3 is a flowchart illustrating a vehicle steering automatic collision avoidance method according to an exemplary embodiment of the disclosure.

FIG. 4 is a schematic illustrating extended turning area determination information in the vehicle steering automatic collision avoidance system according to an exemplary embodiment of the disclosure.

FIG. 5 is a schematic illustrating steering system threshold variation information in the vehicle steering automatic collision avoidance system according to an exemplary embodiment of the disclosure.

FIG. 6 is a schematic illustrating vehicle future movement trajectory prediction information in the vehicle steering automatic collision avoidance system according to an exemplary embodiment of the disclosure.

FIG. 7 is a schematic illustrating vehicle future movement trajectory prediction information including a future movement trajectory extension line, a warning window, and a warning area according to an exemplary embodiment of the disclosure.

### DETAILED DESCRIPTION OF THE INVENTION

In order to provide a clearer understanding of the present disclosure, several preferred embodiments are exemplified and illustrated in detail below in accompany with drawings so as to provide the public with an in-depth understanding and recognition of the present disclosure. It is noted that the embodiments described herein are exemplified and illustrated purposes only and are not intended to limit the scope of the present application

The present disclosure is further described in detail below to facilitate a thorough understanding of the present disclosure. However, the embodiments described are a portion of all possible embodiments, not all embodiments. All other embodiments that can be easily achieved by those with ordinary knowledge in the art based on the embodiments of the present disclosure are considered to fall within the scope of protection intended by the present disclosure.

The descriptions described below of “first”, “second”, etc., are used for descriptive purposes only and cannot be understood as indicating or implying their relative significance, or as implicit indication of a quantity of indicated technical features. Therefore, features defined and depicted as “first” and “second” may be considered explicitly or implicitly that at least one of the features is included. In the descriptions of some embodiments of the present disclosure, the terms “exemplary”or “for example”are used to illustrate or explain by way of example. Unless otherwise defined, all technical and scientific terms used herein have the same meaning as commonly understood by one with ordinary knowledge in the art to which the present disclosure belongs. The terminology used in the description of the present disclosure is only for the purpose of describing particular embodiments and is not intended to limit the scope of the present application.

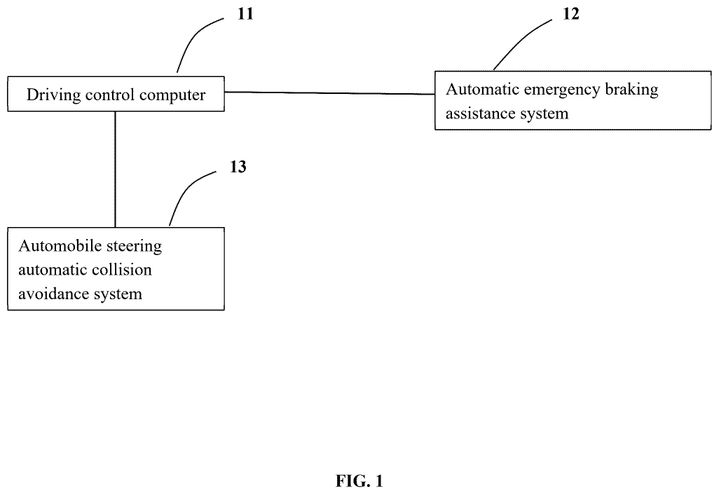

Please refer to FIG. 1, FIG. 1 is a block diagram illustrating a vehicle steering automatic collision avoidance system 1 according to an exemplary embodiment of the disclosure. The vehicle steering automatic collision avoidance system 1 may be applied for a vehicle, the vehicle steering automatic collision avoidance system 1 includes a driving control computer 11, an automatic emergency braking assistance system 12, and an automobile steering automatic collision avoidance system 13. The driving control computer 11 is connected to both the automatic emergency braking assistance system 12 and the automobile steering automatic collision avoidance module 13. When the steering-automatic collision avoidance module 13 is activated, it may provide a collision warning 1342 and steering collision avoidance decision information 1341 to the driving control computer 11. The driving control computer 11 may integrate the steering collision avoidance decision information 1341 and the automatic emergency braking assistance information 123 provided by the automatic emergency braking assistance system 12. The vehicle as described in the present disclosure can include but not limited to automobiles, electric vehicles, low-speed vehicles, and other powered vehicles operating on roads.

In an exemplary embodiment of the present disclosure, the automatic emergency braking assistance system 12 includes a millimeter-wave radar module 121. The millimeter-wave radar module 121 transmits electromagnetic waves toward the target object ahead of the vehicle and receives reflectivity to obtain the distance, speed, and angle of the target. The millimeter-wave radar module 121 provides millimeter-wave radar information. The operating frequencies of the vehicle millimeter-wave radar may be at 24 GHz, 77 GHz, or 79 GHz. In another embodiment of the present disclosure, the automatic emergency braking assistance system 12 may also include an image recognition module 122. The image recognition module 122 identifies obstacles such as pedestrians, bicycles, and vehicles by a camera. The image recognition module 122 provides image recognition module information. The driving control computer 11 may integrate and analyze the millimeter-wave radar information and/or the image recognition module information to generate automatic emergency braking assistance information 123.

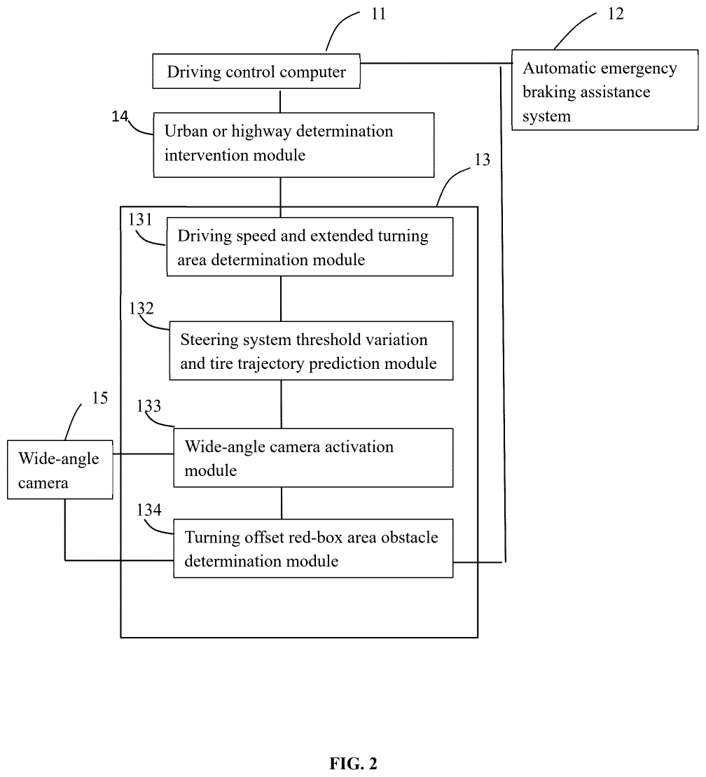

Please refer to FIG. 2, FIG. 2 is a block diagram illustrating a vehicle steering automatic collision avoidance system 1 including an urban or highway determination intervention module 14 and an automobile steering automatic collision avoidance system 13 according to an exemplary embodiment of the disclosure. The urban or highway determination intervention module 14 may provide urban or highway road information 141. The driving control computer 11 may activate the automobile steering automobile collision avoidance system 13 according to the urban or highway road information 141. In an embodiment, the urban or highway determination intervention module 14 may use a traffic sign recognition system to capture the urban or highway road information 141. The traffic sign recognition system captures dynamic road information surrounding the vehicle through image recognition and determines the current road type by identifying road traffic signs and markings. For example, highways and expressways typically include specific signage or symbols for identification. By recognizing these images, the system can determine whether the current vehicle is traveling on a highway or a surface road. The traffic sign recognition system continuously monitors the current road status. When it is determined that the vehicle is on a highway or expressway, the automobile steering automatic collision avoidance system 13 may remain in an idle state. Once the exit sign is recognized, the automobile steering automatic collision avoidance system 13 may be activated again. The exit signs may include, but are not limited to, exit signs indicated by road traffic signs and road surface markings, exit signs, traffic lights, and other signs and markings. In another embodiment, the urban or highway determination intervention module 14 may also use navigation map data to capture dynamic road information surrounding the vehicle.

When the driving control computer 11 determines the vehicle is currently on an urban road based on the urban or expressway information 141, the automobile steering automatic collision avoidance system 13 may be activated. The automobile steering automatic collision avoidance system 13 includes a driving speed and extended turning area determination module 131, a steering system threshold variation and tire trajectory prediction module 132, a wide-angle camera activation module 133, and a turning offset red-box area obstacle determination module 134. The driving speed and extended turning area determination module 131 may provide extended turning area determination information 1311. The steering system threshold variation and tire trajectory prediction module 132 may provide steering system threshold variation information 1321 and vehicle future movement trajectory prediction information 1322. The wide-angle camera activation module 133 may determine and provide a wide-angle activation signal 1331 to a wide-angle camera 15 based on the extended turning area determination information 1311 and the steering system threshold variation information 1321. The wide-angle camera 15 may provide wide-angle camera information 151. The turning offset red-box area obstacle determination module 134 may provide a collision warning 1342 and steering collision avoidance decision information 1341 to the driving control computer 11 based on the wide-angle camera information 151.

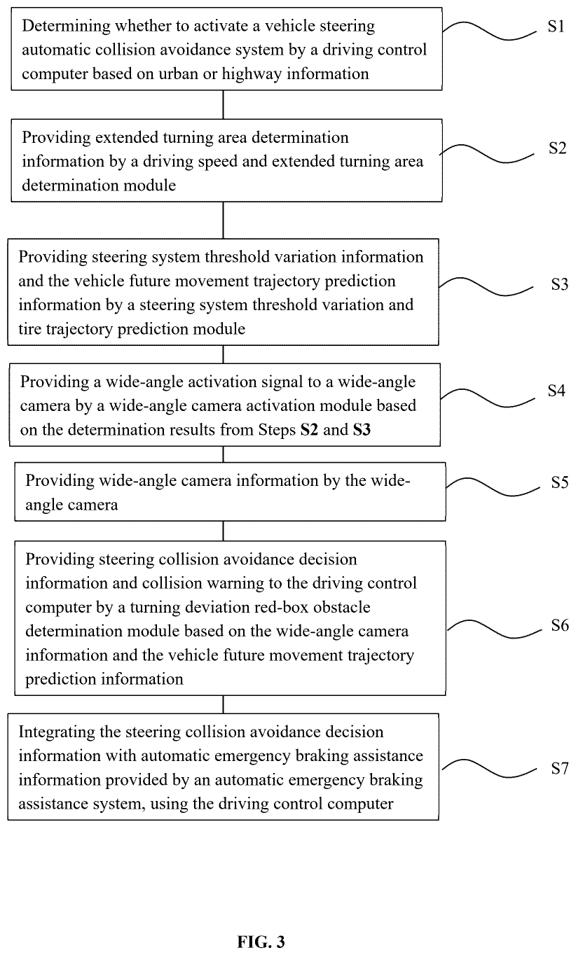

Please refer to FIG. 3, FIG. 3 is a flowchart illustrating a vehicle steering automatic collision avoidance method according to an exemplary embodiment of the disclosure. The vehicle steering automatic collision avoidance method includes: Step S1: determining whether to activate an automobile steering collision avoidance system 13 based on the urban or highway road information a driving control computer 11; Step S2: Providing extended turning area determination information 1311 by a driving speed and extended turning area determination module 131; Step S3: providing steering system threshold variation information 1321 and vehicle future movement trajectory prediction information 1322 by a steering system threshold variation and tire trajectory prediction module 132; Step S4: providing a wide-angle activation signal 1331 to a wide-angle camera 15 by a wide-angle camera activation module 133 based on the determination results from Steps S2 and S3; Step S5: providing wide-angle camera information 151 by the wide-angle camera 15; Step S6: providing steering collision avoidance decision information 1341 and collision warning 1342 to the driving control computer 11 by a turning deviation red-box obstacle determination module 134 based on the wide-angle camera information 151 and the vehicle future movement trajectory prediction information 1322; Step S7: integrating the steering collision avoidance decision information 1341 with automatic emergency braking assistance information 123 provided by an automatic emergency braking assistance system 12, using the driving control computer 11.

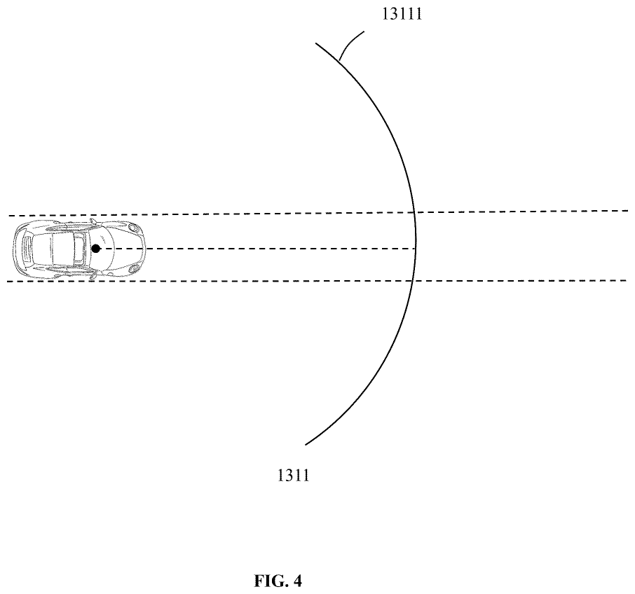

In Step S2 described above, the driving speed and extended turning area determination module 131 provides extended turning area determination information 1311. Please refer to FIG. 4, FIG. 4 is a schematic illustrating extended turning area determination information 1311 in the vehicle steering automatic collision avoidance system 1 according to an exemplary embodiment of the disclosure. The extended turning area determination information 1311 may include a turning determination distance 13111 extended and determined based on the forward speed of the vehicle. The turning determination distance 13111 may include, but is not limited to, the following examples for surface roads: when the forward speed of the vehicle is 10 km/h, the turning determination distance 13111 may be 5 meters; when the forward speed of the vehicle is 20 km/h, the distance may be 8 meters; when the forward speed of the vehicle is 30 km/h, the distance may be 12 meters; when the forward speed of the vehicle is 40 km/h, the distance may be 16 meters; when the forward speed of the vehicle is 50 km/h, the distance may be 30 meters; and when the forward speed of the vehicle is 60 km/h, the distance may be 35 meters. Understandably, the numerical values of the turning determination distance 13111 mentioned above are only exemplary. The turning determination distance 13111 of the present disclosure may be preset differently according to various forward speed of the vehicle and vehicle typed without departing from the scope or spirit of the disclosure.

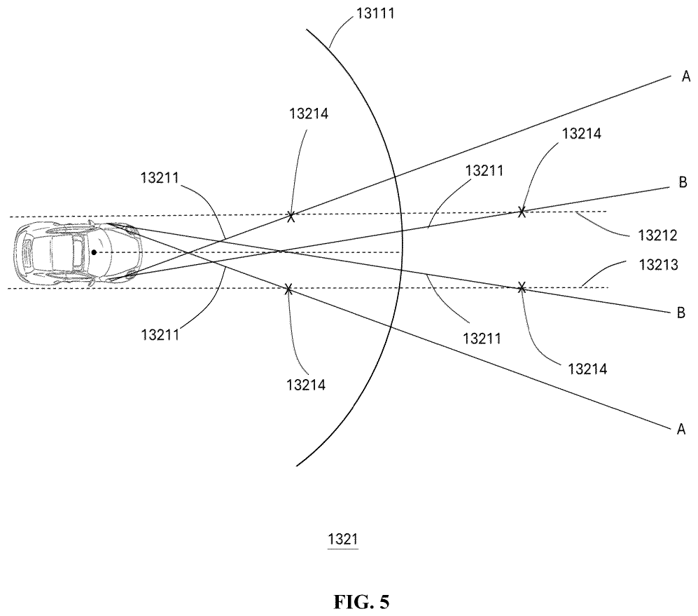

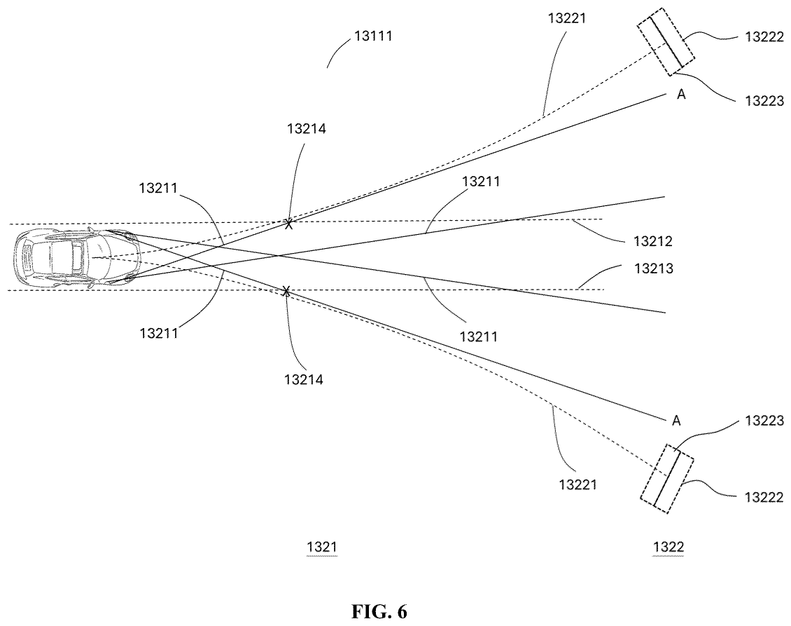

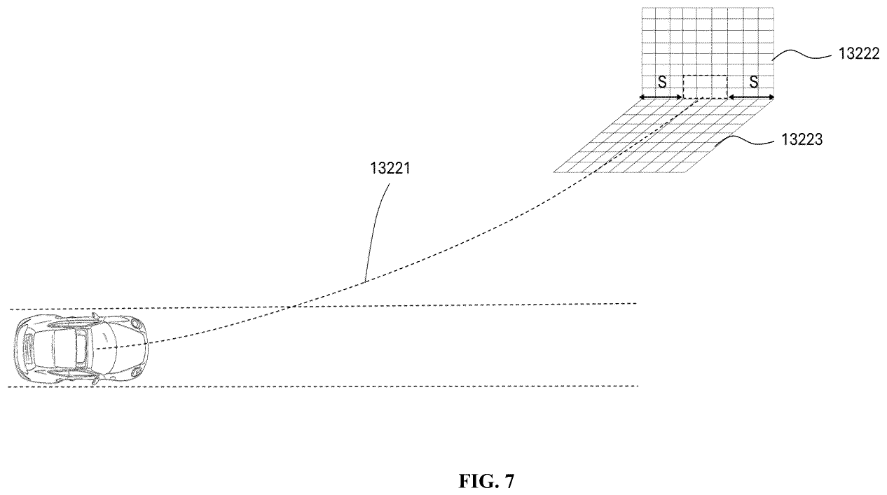

In Step S3 described above, the steering system threshold variation and tire trajectory prediction module 132 provides steering system threshold variation information 1321 and vehicle future movement trajectory prediction information 1322. Referring to FIG. 5, FIG. 5 is a schematic illustrating steering system threshold variation information 1321 in the vehicle steering automatic collision avoidance system 1 according to an exemplary embodiment of the disclosure. Referring to FIG. 6, FIG. 6 is a schematic illustrating vehicle future movement trajectory prediction information 1322 in the vehicle steering automatic collision avoidance system 1 according to an exemplary embodiment of the disclosure. As shown in FIG. 5, the steering system threshold variation information 1321 includes a tire rotation direction extension line 13211, a left-side threshold 13212, and a right-side threshold 13213. The tire rotation direction extension line 13211 varies according to the tire's turning direction. This tire rotation direction extension line 13211 and the left-side threshold 13212 or right-side threshold 13213 may form an intersection point 13214. When the vehicle turns left, the intersection point 13214 is formed by the tire rotation direction extension line 13211 of the right tire and the left-side threshold 13212. When the vehicle turns right, the intersection point 13214 is formed by the tire rotation direction extension line 13211 of the left tire and the right-side threshold 13213. The steering system threshold variation and tire trajectory prediction module 132 determines whether the vehicle is in a turning operation (A), lane-change operation (B), or in a brief directional change within a curve operation (C) (not shown), based on the position of the tire rotation direction extension line 13211, the left-side threshold 13212 or a right-side threshold 13213, and the intersection point 13214. For example, when the forward speed of the vehicle. is 60 km/h, and the turning determination distance 13111 is set to 35 meters, if the intersection point 13214, formed by the tire rotational direction extension line 13211 and either the left-side threshold 13212 or the right-side threshold 13213, falls beyond 35 meters, such as at 45 meters, it can be determined that the vehicle is performing a lane change operation (B). If the intersection point 13214, formed by the tire rotational direction extension line 13211 and either the left-side threshold 13212 or the right-side threshold 13213, falls within 35 meters, such as at 25 meters, it can be determined that the vehicle is in a turning operation (A). This determination must last for at least 1 second before performing the next step to avoid misjudgment caused by short-term changes. Understandably, the determination time is a preset value, which may be adjusted based on actual scenarios. Whether it is 0.5 sec, 0.75 sec, 1 sec, 1.25 sec, or 1.5 sec., as long as the determination time is sufficient to determine whether the vehicle is in the turning operation A, the lane change B, or the brief directional change within a curve operation C. As shown in FIG. 6 and FIG. 7, FIG. 7 is a schematic illustrating vehicle future movement trajectory prediction information 1322 including a future movement trajectory extension line 13221, a warning window 13222, and a warning area 13223, according to an exemplary embodiment of the disclosure in which the vehicle is turning left. The vehicle future movement trajectory prediction information 1322 may include a future movement trajectory extension line 13221, a warning window 13222, and a warning area 13223 extending and formed based on the forward speed of the vehicle and the rotational direction of both front wheels. The width of the warning window 13222 and the warning area 13223 equals the vehicle body width plus a steering collision avoidance safety distance S. In one embodiment, the steering collision avoidance safety distance S may be set to 5 meters beyond the section width of the tire. However, it is understood that the steering collision avoidance safety distance S may be appropriately adjusted based on the forward speed of the vehicle.

If the vehicle is determined to be in a turning operation A based on the extended turning area determination information 1311 of Step S2 and the steering system threshold variation information 1321 of Step S3, Step S4 may be performed. When the vehicle is determined to be in the turning operation A, a wide-angle camera activation module 133 provides a wide-angle activation signal 1331 to a wide-angle camera 15. The wide-angle activation signal 1331 may activate the wide-angle camera 15. In one embodiment, the wide-angle camera 15 is mounted on the inner surface of the windshield behind the rearview mirror to obtain the maximum horizontal field of view near the driver's position. A conventional camera typically has a horizontal angle of view of approximately 60 degrees, whereas the wide-angle camera 15 in the embodiment can achieve a horizontal field of view of approximately 120 degrees and a diagonal field of view of approximately 150 degrees, allowing for a preemptive viewing angle that covers the area behind the A-pillar.

In Step S5, the wide-angle camera 15 provides wide-angle camera information 151. When the wide-angle camera 15 is activated, it provides the wide-angle camera information 151. Understandably, the wide-angle camera activation module 133, the wide-angle camera 15, and the wide-angle camera information 151 provided in the disclosure may also be a zoom camera, such as a zoom camera switching module, a near-focus camera, and near-focus camera information. During normal driving, a telephoto camera may be used. When the vehicle is in the turning operation A, the camera may switch to the near-focus camera and provide near-focus camera information. Whether a camera or a lens is used, it can be easily accomplished by a person having ordinary skill in the art without departing from the scope of the present disclosure. In another embodiment, when the wide-angle camera 15 is activated, a speed limiting system may also be activated at the same time to reduce the vehicle speed to within a safe range for turning, thereby loss of control or sudden acceleration is prevented. In still another embodiment, when the wide-angle camera 15 is activated, the speed limiting system mentioned above may be simultaneously activated or deactivated together with the traction control system (TCS).

In Step S6, a turning-offset red-box obstacle determination module 134 determines whether a person, vehicle, or object has entered a warning window 13222, based on the wide-angle camera information 151, the future movement trajectory extension line 13221, and the warning window 13222. And big data computing is used to determine whether the steering collision-avoidance decision information 1341 should be transmitted to the driving control computer 11.

The big data computing described in the present disclosure may include, but is not limited to, architectures such as convolutional neural networks (CNN).

In another embodiment, before issuing the steering collision-avoidance decision information 1341, a collision warning 1342 may first be issued to alert the driver. If the activation condition remains after a preset time following the issuance of the collision warning 1342, the steering collision-avoidance decision information 1341 may be issued.

In Step S7, the driving control computer 11 may activate the autonomous emergency braking assistance system 12 based on the steering collision-avoidance decision information 1341. When the driving control computer 11 receives the steering collision-avoidance decision information 1341, the driving control computer 11 may integrate the autonomous emergency braking assistance information with the steering collision-avoidance decision information 1341 to determine whether to activate the autonomous emergency braking assistance system 12 for active brake intervention.

In the Steps S1 to S3 mentioned above, when the vehicle is determined to be no longer in the turning operation A, the wide-angle camera activation module 133 may not provide the wide-angle activation signal 1331 to the wide-angle camera 15, thereby deactivating the wide-angle camera 15. Understandably, in another embodiment, it can be configured that not only when the vehicle is determined to be no longer in the turning operation A, but also until the tire rotation direction extension line 13211 returns to the tangent, the wide-angle camera activation module 133 does not provide the wide-angle activation signal 1331 to the wide-angle camera 15, thereby deactivating the wide-angle camera 15.

The convolutional neural network (CNN) is used as an example in the vehicle steering automatic collision avoidance system 1 of the present disclosure; however, the algorithm used is not limited to CNNs. The steps of the CNN used in vehicle steering automatic collision avoidance system 1 may include: CNN1: establishing a steering information and angle database, including data collection: using cameras and sensors to collect vehicle steering information and steering system angle data. These data are used to establish a database that records vehicle response characteristics at different steering angles; CNN model training: using CNN trained on these data to extract features, and learn behavior patterns of the vehicle under various steering conditions. CNN2: calculating tire trajectories and generating trajectory map, including: trajectory prediction: based on the output of the CNN model, the predicted trajectory of the tires is calculated, which is used to determine the vehicle's future driving path; drawing the trajectory map: visualizing the predicted trajectory in image form to obtain a future movement trajectory extension line 13221, and marking the steering collision avoidance safety distance range beyond the front wheel trajectory on the image as a warning window 13222 and warning area 13223. CNN3: segmenting the trajectory map and calculating weight variation, including region segmentation: dividing the warning window 13222 and warning area 13223 on the trajectory map into n² small boxes, each representing an independent detection unit, or using adaptive grid segmentation or dynamic segmentation based on key regions to reduce segmentation complexity and thereby maintain accuracy while minimizing unnecessary computation; weight calculation: applying a data model to each small box to calculate the weight variation reflecting the edge features and their changes within each region. A multimodal perception system is used to allow the model to dynamically adapt to environmental changes during operation. CNN4: real-time monitoring and image analysis, including: image monitoring: monitoring each segmented box in real-time to detect changes in image content. For example, Full HD resolution with 60 frames per second (FPS) can be used for analysis. Understandably, the frame rate can be adjusted (e.g., 10, 20, 30, 40, 50, or 60 fps) depending on the actual requirements for detecting and identifying obstacles such as pedestrians, bicycles, and vehicles. Optimization algorithm and the balancing of processing speed and accuracy during actual operation are used to reduce latency in Full HD resolution analysis; feature detection and comparison: comparing image changes between the previous and current frames to identify objects rapidly entering the warning window 13222. If the change exceeds a preset threshold, a potential danger is indicated. Advanced object detection technologies such as Faster R-CNN or YOLO may be used to enhance detection accuracy for various objects. Dynamic thresholds or risk-based adaptive thresholds may also be used, adjusting dynamically according to vehicle speed, environmental changes, and road conditions to enhance system adaptability in different scenarios. CNN5: collision warning and automatic emergency braking (AEB), including: collision warning: once the system detects a potential collision risk, such as a rapidly approaching object entering the warning area, a collision warning 1342 is immediately issued to alert the driver by the system; automatic emergency braking assistance system 12 activation: if the system further confirms the collision risk or detects non-road traffic signs (e.g., pedestrians on a crosswalk or animals) in the image, it will automatically activate the automatic emergency braking assist system 12 to prevent a collision. CNN6: system performance and adjustment, including continuous learning: the system features reinforcement learning and adaptive algorithms to continuously learn and optimize the accuracy and response speed of the model. This allows it to handle complex road environments and diverse driving conditions; model accuracy optimization: adjusting model parameters such as weight variation thresholds, region segmentation size, and CNN depth/layers based on real conditions to enhance accuracy and system stability.

In order to reduce the heavy computational load and decision-making demand of CNNs and to prevent misjudgments caused by image delays, a GoogleLeNet AI model may also be used. Under the same computational conditions, GoogleLeNet can effectively reduce the number of layers and image segmentation units, thereby significantly decreasing the amount of data and the number of decision points the in-vehicle computer must process. This allows more computational resources to be allocated to increasing the video frame rate, enabling quicker detection of edge changes and earlier identification of pedestrians or obstacles.

According to the above description, the vehicle steering automatic collision avoidance system of the present disclosure has fully met statutory patentability requirements of industrial applicability, and therefore is filed under the patent law. However, the above detailed descriptions are provided only as an explicit illustration description of feasible preferred embodiments of the present disclosure. They are not used to limit the claimed scope of the present disclosure. Any equivalent implementation or modification that does not depart from a technical spirit of the present disclosure should be included within the claimed scope of the present patent application.

What is claimed is:

1. A vehicle steering automatic collision avoidance system comprising:
a driving control computer connected to an autonomous emergency braking assistance system and an automobile steering automatic collision avoidance system;
wherein the autonomous emergency braking assistance system is configured to provide autonomous emergency braking assistance information;
wherein the vehicle steering automatic collision avoidance system is configured to provide steering collision-avoidance decision information, when activated;
wherein the driving control computer is capable of integrating the autonomous emergency braking assistance information and the steering collision-avoidance decision information; and
an urban or highway determination and intervention module providing urban or highway road information, wherein the driving control computer activates the automobile steering automatic collision avoidance system based on the urban or highway road information.

2. The vehicle steering automatic collision avoidance system as claimed in claim 1, wherein the automobile steering automatic collision avoidance system further comprises a driving speed and extended turning area determination module configured to provide extended turning area determination information.

3. The vehicle steering automatic collision avoidance system as claimed in claim 2, wherein the automobile steering automatic collision avoidance system further comprises a steering system threshold variation and tire trajectory prediction module configured to provide steering system threshold variation information and vehicle future movement trajectory prediction information.

4. The vehicle steering automatic collision avoidance system as claimed in claim 3, wherein the automobile steering automatic collision avoidance system further comprises a wide-angle camera activation module configured to provide a wide-angle activation signal to a wide-angle camera based on the extended turning area determination information and the vehicle future movement trajectory prediction information.

5. The vehicle steering automatic collision avoidance system as claimed in claim 4, wherein the wide-angle camera is configured to provide wide-angle camera information.

6. The vehicle steering automatic collision avoidance system as claimed in claim 5, wherein the automobile steering automatic collision avoidance system further comprises a turning-offset red-frame obstacle determination module configured to provide steering collision avoidance decision information to the driving control computer based on the wide-angle camera information and the vehicle future movement trajectory prediction information.

7. The vehicle steering automatic collision avoidance system as claimed in claim 1, wherein the urban or highway determination and intervention module is a traffic sign recognition system.

8. The vehicle steering automatic collision avoidance system as claimed in claim 2, wherein the extended turning area determination information comprises a turning determination distance.

9. The vehicle steering automatic collision avoidance system as claimed in claim 3, wherein the steering system threshold variation information comprises a tire rotation direction extension line, a left-side threshold, and a right-side t threshold.

10. The vehicle steering automatic collision avoidance system as claimed in claim 9, wherein the vehicle future movement trajectory prediction information comprises a future movement trajectory extension line, a warning window, and a warning area.

11. A vehicle steering automatic collision avoidance method, comprising the following steps:
Step S1: determining whether to activate an automobile steering automatic collision avoidance system by a driving control computer based on urban or highway information;
Step S2: providing extended turning area determination information by a driving speed and extended turning area determination module;
Step S3: providing steering system threshold variation information and vehicle future movement trajectory prediction information by a steering system threshold variation and tire trajectory prediction module;
Step S4: providing a wide-angle activation signal to a wide-angle camera by a wide-angle camera activation module based on the determination results of Steps S2 and S3;
Step S5: providing wide-angle camera information by the wide-angle camera;
Step S6: providing steering collision avoidance decision information to the driving control computer by a turning offset red-box obstacle determination module based on the wide-angle camera information and the vehicle future movement trajectory prediction information; and
Step S7: integrating the steering collision avoidance decision information with automatic emergency braking assistance information provided by an automatic emergency braking assistance system, using the driving control computer.

12. The vehicle steering automatic collision avoidance method as claimed in claim 11, wherein the extended turning area determination information comprises a turning determination distance, and the turning determination distance varies in accordance with the forward speed of the vehicle.

13. The vehicle steering automatic collision avoidance method as claimed in claim 12, wherein the steering system threshold variation information comprises a tire rotation direction extension line, a left-side threshold, and a right-side threshold, wherein the tire rotation direction extension line and the left-side threshold or the right-side threshold form an intersection point, and a turning operation of the vehicle is determined based on a relative position between the intersection point and the turning determination distance.

14. The vehicle steering automatic collision avoidance method as claimed in claim 13, wherein the vehicle future movement trajectory prediction information comprises a future movement trajectory extension line, a warning window, and a warning area.
